(19) United States
(12) Patent Application Publication
(10) Pub. No.: US 2020/0255016 A1
(43) Pub. Date: Aug. 13, 2020

(54) VEHICLE CONTROL DEVICE, VEHICLE, AND VEHICLE CONTROL METHOD

(71) Applicant: HONDA MOTOR CO., LTD., Tokyo (JP)

(72) Inventors: Kanta TSUJI, WAKO-SHI (JP); Yuji FUJIKI, WAKO-SHI (JP); Hironobu KIRYU, WAKO-SHI (JP); Hideharu TAKAMIYA, WAKO-SHI (JP); Yuma YOSHIDA, WAKO-SHI (JP); Daichi KATO, WAKO-SHI (JP)

(21) Appl. No.: 16/783,758

(22) Filed: Feb. 6, 2020

(30) Foreign Application Priority Data
Feb. 7, 2019 (JP) 2019-020223

(51) Int. Cl. B60W 30/18; B60W 30/12; B60W 50/14; B60W 50/10

(52) U.S. Cl. CPC B60W 30/18163; B60W 30/12; B62D 1/046; B60W 50/10; B60W 2540/215; B60W 50/14

(57) ABSTRACT

A vehicle control device includes an operation detection unit that detects an operation input performed by a user to an operation input unit, to which a first operation input to instruct activation or termination of a predetermined function and a second operation input to instruct suspension of the predetermined function can be performed, and a lane change control unit that controls a lane change on the basis of the operation input performed by the user in response to the lane change proposal issued in a state where the predetermined function is operating. The lane change control unit carries out the lane change in the case that the first operation input is performed by the user in response to the lane change proposal, and does not carry out the lane change in the case that the second operation input is performed by the user in response to the lane change proposal.

### CROSS-REFERENCE TO RELATED APPLICATION

This application is based upon and claims the benefit of priority from Japanese Patent Application No. 2019-020223 filed on Feb. 7, 2019, the contents of which are incorporated herein by reference.

### BACKGROUND OF THE INVENTION

### Field of the Invention

The present invention relates to a vehicle control device, a vehicle, and a vehicle control method.

### Description of the Related Art

Recently, vehicle control devices have been proposed which are capable of controlling a lane change. In Japanese Patent No. 5970513, it is disclosed that, in response to a lane change proposal, in the case that the driver has operated a turn signal lever in an opposite direction, a determination is made that the driver does not agree with the lane change.

### SUMMARY OF THE INVENTION

However, the proposed vehicle control device is not capable of always realizing sufficiently suitable operability.

An object of the present invention is to provide a vehicle control device, a vehicle, and a vehicle control method having suitable operability.

A vehicle control device according to an aspect of the present invention comprises a proposal unit configured to issue a lane change proposal, which is a proposal to make a lane change, to a user, an operation detection unit configured to detect an operation input performed by the user to an operation input unit, to which a first operation input to instruct activation or termination of a predetermined function and a second operation input to instruct suspension of the predetermined function are configured to be performed, and a lane change control unit configured to control the lane change on a basis of the operation input performed by the user in response to the lane change proposal issued by the proposal unit in a state in which the predetermined function is operating, wherein the lane change control unit carries out the lane change in a case that the first operation input is performed by the user in response to the lane change proposal issued by the proposal unit, and does not carry out the lane change in a case that the second operation input is performed by the user in response to the lane change proposal issued by the proposal unit.

A vehicle according to another aspect of the present invention comprises the vehicle control device as described above.

A vehicle control method according to another aspect of the present invention comprises a step of issuing a lane change proposal, which is a proposal to make a lane change, to a user, a step of detecting an operation input performed by the user to an operation input unit, to which a first operation input to instruct activation or termination of a predetermined function and a second operation input to instruct suspension of the predetermined function are configured to be performed, and a step of controlling the lane change on a basis of the operation input performed by the user in response to the lane change proposal issued in a state in which the predetermined function is operating, wherein, in the step of controlling the lane change, the lane change is carried out in a case that the first operation input is performed by the user in response to the lane change proposal, and the lane change is not carried out in a case that the second operation input is performed by the user in response to the lane change proposal.

According to the present invention, it is possible to provide a vehicle control device, a vehicle, and a vehicle control method having suitable operability.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing a vehicle according to an embodiment of the present invention;

FIG. 2 is a diagram illustrating an example of an operation input unit provided in the vehicle according to the embodiment of the present invention;

FIG. 3 is a view showing an example of a travel lane;

FIG. 4 is a flowchart showing an example of operations of the vehicle control device according to the embodiment;

FIG. 5 is a flowchart illustrating an example of operations of the vehicle control device according to a first modification of the embodiment; and

FIG. 6 is a flowchart illustrating an example of operations of the vehicle control device according to a second modification of the embodiment.

### DESCRIPTION OF THE PREFERRED EMBODIMENTS

Preferred embodiments of a vehicle control device, a vehicle, and a vehicle control method according to the present invention will be presented and described in detail below with reference to the accompanying drawings.

### Embodiment

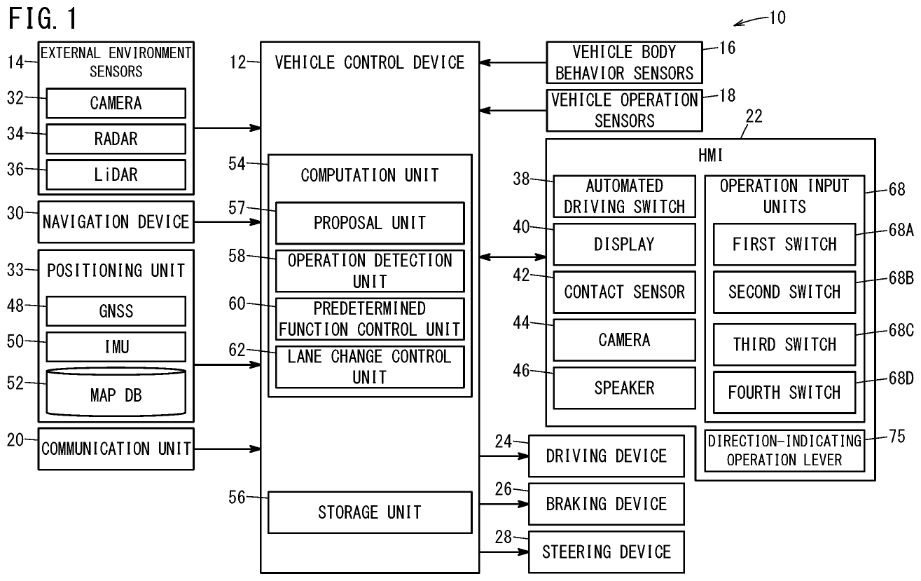

A vehicle control device, a vehicle, and a vehicle control method according to embodiments of the present invention will be described with reference to the drawings. FIG. 1 is a block diagram showing a vehicle according to the present embodiment.

The vehicle (host vehicle) 10 is equipped with a vehicle control device 12, namely, a vehicle control ECU (Electronic Control Unit). The vehicle 10 is further equipped with external environment sensors 14, vehicle body behavior sensors 16, vehicle operation sensors 18, a communication unit 20, and an HMI (Human Machine Interface) 22. The vehicle 10 is further equipped with a driving device 24, a braking device 26, a steering device 28, a navigation device 30, and a positioning unit 33. Although the vehicle 10 is equipped with other constituent elements apart from those noted above, description of such elements is omitted herein.

The external environment sensors 14 acquire external environmental information, that is, peripheral information around the vicinity of the vehicle 10. The external environment sensors 14 include a plurality of cameras 32 and a plurality of radar devices 34. Among the external environment sensors 14, there are further included a plurality of LiDAR (Light Detection And Ranging, Laser Imaging Detection and Ranging) devices 36.

Information acquired by cameras (imaging units) 32, i.e., camera information, is supplied from the cameras 32 to the vehicle control device 12. As such camera information, there may be cited captured image information and the like. The camera information, together with radar information and LiDAR information to be described later, makes up the external environmental information. Although a single camera 32 is illustrated in FIG. 1, a plurality of cameras 32 are actually provided.

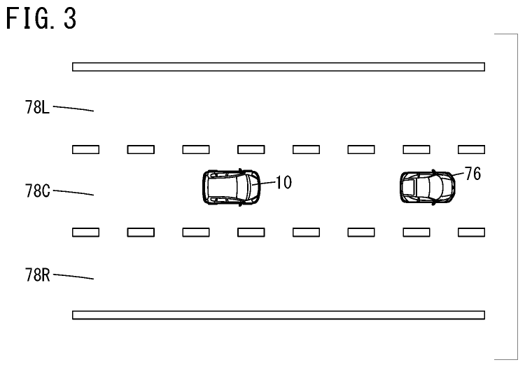

The radar devices 34 emit transmitted waves toward the exterior of the vehicle 10, and receive reflected waves that are reflected and returned by detected objects. As examples of the transmitted waves, there may be cited electromagnetic waves. As examples of the electromagnetic waves, there may be cited millimeter waves. As examples of the detected objects, there may be cited another vehicle 76 including a preceding vehicle (see FIG. 3). The radar devices 34 generate radar information (reflected wave signals) based on the reflected waves or the like. The radar devices 34 supply the generated radar information to the vehicle control device 12. Although one radar device 34 is illustrated in FIG. 1, a plurality of radar devices 34 are actually provided in the vehicle 10. Moreover, the radar devices 34 are not limited to using millimeter wave radar. For example, laser radar devices, or ultrasonic sensors or the like may be used as the radar devices 34.

The LiDAR devices 36 continuously irradiate lasers in all directions of the vehicle 10, measure the three dimensional positions of reflection points based on reflected waves of the emitted lasers, and output information, i.e., three dimensional information, in relation to the three dimensional positions. The LiDAR devices 36 supply the three dimensional information, i.e., LiDAR information, to the vehicle control device 12. Although one LiDAR device 36 is illustrated in FIG. 1, a plurality of LiDAR devices 36 are actually provided in the vehicle 10.

The vehicle body behavior sensors 16 acquire information, namely, vehicle body behavior information, in relation to the behavior of the vehicle 10. The vehicle body behavior sensors 16 include a non-illustrated vehicle speed sensor, non-illustrated vehicle wheel speed sensors, a non-illustrated acceleration sensor, and a non-illustrated yaw rate sensor. The vehicle speed sensor detects the speed, i.e., the vehicle speed, of the vehicle 10. Further, the vehicle speed sensor detects the direction in which the vehicle 10 is traveling. The vehicle wheel speed sensors detect the speed, i.e., the vehicle wheel speed, of the non-illustrated vehicle wheels. The acceleration sensor detects the acceleration of the vehicle 10. The term “acceleration” includes a longitudinal acceleration, a lateral acceleration, and a vertical acceleration. It should be noted that the acceleration of only a portion of the aforementioned directions may be detected by the acceleration sensor. The yaw rate sensor detects a yaw rate of the vehicle 10.

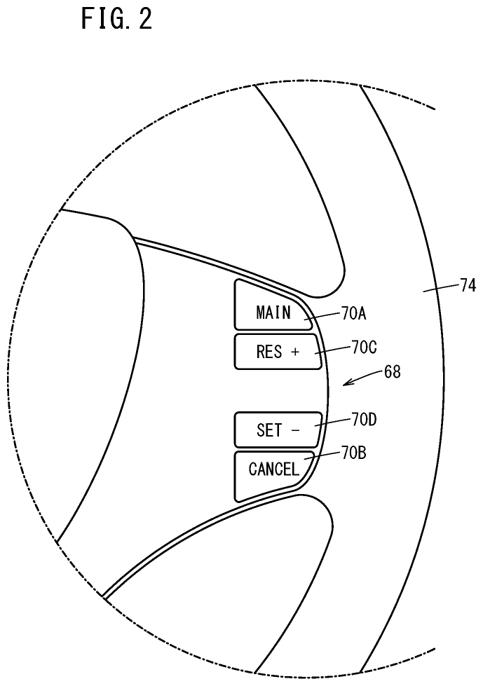

The vehicle operation sensors (driving operation sensors) 18 acquire information, namely, driving operation information, in relation to driving operations made by a user (driver). The vehicle operation sensors 18 include a non-illustrated accelerator pedal sensor, a non-illustrated brake pedal sensor, a non-illustrated steering angle sensor, and a non-illustrated steering torque sensor. The accelerator pedal sensor detects an operated amount of a non-illustrated accelerator pedal. The brake pedal sensor detects an operated amount of a non-illustrated brake pedal. The steering angle sensor detects the steering angle of a steering wheel 74 (see FIG. 2). The torque sensor detects a torque applied to the steering wheel 74.

The communication unit 20 performs wireless communications with non-illustrated external equipment. The external equipment may include, for example, a non-illustrated external server. The communication unit 20 may be capable of being detached from the vehicle 10, or may be non-detachable with respect to the vehicle. As examples of the communication unit 20 that can be attached to and detached from the vehicle 10, there may be cited a mobile phone and a smartphone.

The HMI 22 receives an operation input made by the user (vehicle occupant), and provides various types of information to the user in a visual, audible, or tactile manner. The HMI 22 includes, for example, an automated driving switch (driving assist switch) 38, a display 40, a contact sensor 42, a camera 44, a speaker 46, an operation input unit 68, and a direction-indicating operation lever 75.

The automated driving switch 38 is used by the user in order to instruct starting or stopping of automated driving. The automated driving switch 38 includes a non-illustrated start switch and a non-illustrated stop switch. The start switch outputs a start signal to the vehicle control device 12 in accordance with an operation of the user. The stop switch outputs a stop signal to the vehicle control device 12 in accordance with an operation of the user.

The display (display unit) 40 includes, for example, a liquid crystal panel or an organic EL panel or the like. In this instance, although an exemplary case will be described in which the display 40 is a touch panel, the present invention is not limited to this feature.

The contact sensor 42 serves to detect whether or not the user (driver) is touching the steering wheel 74. Signals output from the contact sensor 42 are supplied to the vehicle control device 12. On the basis of input signals supplied from the contact sensor 42, the vehicle control device 12 is capable of determining whether or not the user is touching the steering wheel 74.

The camera 44 captures images of the interior, i.e., a non-illustrated vehicle compartment interior, of the vehicle 10. The camera 44 may be disposed, for example, on a non-illustrated dashboard, or may be disposed on a non-illustrated ceiling of the vehicle. Further, the camera 44 may be disposed in a manner so that images are captured of only the driver, or may be disposed in a manner so that images are captured of each of the vehicle occupants. The camera 44 outputs information, i.e., image information, which is acquired by capturing images of the vehicle compartment interior, to the vehicle control device 12.

The speaker 46 serves to provide various types of information to the user by way of sound or voice. The vehicle control device 12 outputs various notifications, alarms, or the like using the speaker 46.

The operation input unit 68 is an operation input unit that differs from the direction-indicating operation lever 75. The operation input unit 68 can be used when the user instructs activation (starting), termination (stopping), or suspension (a standby state) of a predetermined function. As the predetermined function, there may be cited a following function, a lane keeping function, or the like. However, the present invention is not limited to this feature. The following function (following travel function) is a function to control traveling of the host vehicle 10 in a manner so that another vehicle 76 (see FIG. 3) that is traveling in front of the host vehicle 10 is followed while a predetermined inter-vehicle distance is maintained between the host vehicle 10 and the other vehicle 76. The lane keeping function is a function of performing a steering control in a manner so that the vehicle 10 travels in the center of a host vehicle lane 78C (see FIG. 3). In this instance, an exemplary case will be described in which the predetermined function is a following function, and more specifically, a case in which the predetermined function is an Adaptive Cruise Control. Such an adaptive cruise control functions so as to maintain the travel speed of the host vehicle 10 at a predetermined travel speed (set travel speed), while keeping the inter-vehicle distance constant even in the case that the accelerator pedal is not depressed by the user. In the adaptive cruise control, in the case that the preceding vehicle 76 exists within a predetermined distance, the travel speed of the host vehicle 10 is controlled so as to maintain the predetermined inter-vehicle distance. Further, in the adaptive cruise control, in the case that the preceding vehicle 76 does not exist within such a predetermined distance, or in the case that the preceding vehicle 76 is not detected, the travel speed of the host vehicle 10 is controlled so as to become a predetermined travel speed.

FIG. 2 is a diagram illustrating an example of an operation input unit provided in the vehicle according to the present embodiment. The operation input unit 68 is provided, for example, on the steering wheel 74. The operation input unit 68 is equipped with, for example, a first input unit (first push button) 70A and a second input unit (second push button) 70B. The operation input unit 68 is further equipped with, for example, a third input unit (third push button) 70C and a fourth input unit (fourth push button) 70D. The operation input unit 68 is equipped with a first switch 68A (see FIG. 1), a second switch 68B (see FIG. 1), a third switch 68C (see FIG. 1), and a fourth switch 68D (see FIG. 1). When the first input unit 70A is pressed, the first switch 68A is placed in an ON state. When the second input unit 70B is pressed, the second switch 68B is placed in an ON state. When the third input unit 70C is pressed, the third switch 68C is placed in an ON state. When the fourth input unit 70D is pressed, the fourth switch 68D is placed in an ON state. The first switch 68A, for example, is a main switch. The second switch 68B, for example, is a cancel switch. The operation input unit 68 supplies signals, which are indicative of operation states set with respect to the first switch 68A, the second switch 68B, the third switch 68C, and the fourth switch 68D, to a later-described operation detection unit 58. The third switch 68C, for example, is a resume switch. The fourth switch 68D, for example, is a set switch.

In the case that the first input unit 70A is pressed in a state in which the adaptive cruise control has not been activated, a computation unit 54 activates the adaptive cruise control. More specifically, in such a case, the computation unit 54 causes the adaptive cruise control to transition into a standby state. In the case that the first input unit 70A is pressed in a state in which the adaptive cruise control is activated, the computation unit 54 terminates (places in an OFF state) the adaptive cruise control. Stated otherwise, in such a case, the computation unit 54 terminates the following control with respect to the preceding vehicle 76. In the case that the fourth input unit 70D is pressed when the travel speed of the host vehicle 10 is greater than or equal to a predetermined speed, and the brake pedal is not being operated, the computation unit 54 performs a control in the following manner. More specifically, in such a case, the computation unit 54 sets the current travel speed of the host vehicle 10 as the set travel speed, and activates the adaptive cruise control. Stated otherwise, in such a case, the computation unit 54 initiates the following control with respect to the preceding vehicle 76. In the case that the brake pedal is operated in a state in which the adaptive cruise control is activated, the computation unit 54 causes the adaptive cruise control to transition into a standby state. Further, in the case that the second input unit 70B is pressed in a state in which the adaptive cruise control is activated, the computation unit 54 causes the adaptive cruise control to transition into the standby state. In the case that the third input unit 70C is pressed in a state in which the set travel speed has already been determined by pressing the fourth input unit 70D, the computation unit 54 reinitiates the adaptive cruise control at the set travel speed. Stated otherwise, in such a case, the computation unit 54 cancels the standby state, and reinitiates the following control with respect to the preceding vehicle 76. In this manner, the first operation input for the purpose of instructing activation or termination of the predetermined function can be performed to the first input unit 70A. Further, the second operation input for the purpose of instructing suspension of the predetermined function can be performed to the second input unit 70B.

The driving device (driving force control system) 24 includes a non-illustrated drive ECU, and a non-illustrated drive source. By controlling the drive source, the drive ECU controls the driving force (torque) of the vehicle 10. As examples of the drive source, there may be cited an engine or a drive motor. The drive ECU is capable of controlling the driving force by controlling the drive source, based on an operation made by the user on the accelerator pedal. Further, the drive ECU is capable of controlling the driving force by controlling the drive source, based on a command supplied from the vehicle control device 12. The driving force of the drive source is transmitted to the non-illustrated vehicle wheels via a non-illustrated transmission.

The braking device (braking force control system) 26 includes a non-illustrated brake ECU, and a non-illustrated brake mechanism. The brake mechanism actuates a brake member by a brake motor, a hydraulic mechanism, or the like. The brake ECU is capable of controlling the braking force by controlling the drive mechanism, based on an operation made by the user on the brake pedal. Further, the brake ECU is capable of controlling the braking force by controlling the brake mechanism, based on a command supplied from the vehicle control device 12.

The steering device (steering system) 28 includes a non-illustrated steering ECU, and more specifically, an EPS (electric power steering system) ECU, and a non-illustrated steering motor. The steering ECU controls the direction of the vehicle wheels (steering wheels) by controlling the steering motor, based on an operation made by the user on the steering wheel 74. Further, the steering ECU controls the direction of the vehicle wheels by controlling the steering motor, based on a command supplied from the vehicle control device 12. Steering may be performed by changing the torque distribution and the braking force distribution to the left and right vehicle wheels.

The navigation device 30 is equipped with a non-illustrated GNSS (Global Navigation Satellite System) sensor. In addition, the navigation device 30 is further equipped with a non-illustrated computation unit and a non-illustrated storage unit. The GNSS sensor detects the current position of the vehicle 10. From a map database stored in the storage unit, the computation unit reads out map information corresponding to the current position detected by the GNSS sensor. Using the map information, the computation unit determines a target route from the current position to a destination. The destination is input by the user via the HMI 22. As described above, the display 40 is a touch panel. The destination is input by the touch panel being operated by the user. The navigation device 30 outputs the created target route to the vehicle control device 12. The vehicle control device 12 supplies the target route to the HMI 22. The HMI 22 displays the target route on the display 40.

The positioning unit 33 is equipped with a GNSS 48. The positioning unit 33 is further provided with an IMU (Inertial Measurement Unit) 50 and a map database (map DB) 52. The positioning unit 33 specifies the position of the vehicle 10 by appropriately using the information obtained by the GNSS 48, the information obtained by the IMU 50, and the map information stored in the map database 52. The positioning unit 33 is capable of supplying host vehicle position information, which is information indicative of the position of the host vehicle 10, to the vehicle control device 12. Further, the positioning unit 33 is capable of supplying the map information to the vehicle control device 12.

The vehicle control device 12 is equipped with the computation unit 54 and a storage unit 56. The computation unit 54 governs the overall control of the vehicle control device 12. The computation unit 54 is constituted, for example, by a CPU (Central Processing Unit). The computation unit 54 executes the vehicle control by controlling each of the respective units based on programs stored in the storage unit 56.

The computation unit 54 is equipped with a proposal unit 57, the operation detection unit 58, a predetermined function control unit 60, and a lane change control unit 62. The proposal unit 57, the operation detection unit 58, the predetermined function control unit 60, and the lane change control unit 62 can be realized by the computation unit 54 executing programs which are stored in the storage unit 56.

The proposal unit 57 issues a lane change proposal, which is a proposal to make a lane change, to the user. The lane change proposal can be issued in a state in which a predetermined function, to be described later, is being executed. However, the present invention is not limited to this feature. The proposal unit 57 issues the lane change proposal to the user using, for example, the HMI 22. More specifically, the proposal unit 57 issues the lane change proposal to the user by way of voice. Such a voice message can be output using the speaker 46.

Moreover, in this instance, although an exemplary case has been described in which the lane change proposal is issued by way of voice, the present invention is not limited to this feature. For example, the lane change proposal may be issued by way of a display. Further, the lane change proposal may be issued by way of a combination of voice and display. Such a lane change proposal by way of a display can be issued using, for example, the display 40 or the like.

On the basis of signals supplied from the operation input unit 68, the operation detection unit 58 detects operation inputs performed by the user to the operation input unit 68. As described above, the signals supplied from the operation input unit 68 are signals indicative of whether each of the first switch 68A and the second switch 68B have been placed in an ON state or an OFF state. The operation detection unit 58 is capable of detecting the first operation input and the second operation input. The first operation input is performed by operating the first input unit 70A. More specifically, the first operation input can be performed by the user pressing the first input unit 70A. The second operation input is performed by operating the second input unit 70B. More specifically, the second operation input can be performed by the user pressing the second input unit 70B.

FIG. 3 is a view showing an example of a travel lane. FIG. 3 shows an example of a case in which the host vehicle 10 and the preceding vehicle 76 are traveling in the host vehicle lane 78C. A first lane (lane, adjacent lane) 78L is located on one side (a left side) of the host vehicle lane (lane) 78C, which is a lane in which the host vehicle 10 is traveling. A second lane (lane, adjacent lane) 78R is located on another side (a right side) of the host vehicle lane (lane) 78C, which is the lane in which the host vehicle 10 is traveling. Moreover, in FIG. 3, an example is illustrated in which only one other vehicle (preceding vehicle) 76 exists in front of the host vehicle 10. However, the present invention is not limited to this feature. There may also be cases in which a plurality of other vehicles 76 are present. Further, there may also be cases in which another vehicle 76 exists in the first lane 78L, or in which another vehicle 76 exists in the second lane 78R.

The predetermined function control unit 60 controls execution of a predetermined function. As the predetermined function, as noted previously, there may be cited a following function, a lane keeping function, or the like. However, the present invention is not limited to this feature. The predetermined function control unit 60 activates or terminates the predetermined function in the case that the first operation input is performed while the lane change proposal is not being carried out by the proposal unit 57. The first operation input, as noted previously, is an operation input to the first input unit 70A. The predetermined function control unit 60 suspends the predetermined function in the case that the second operation input is performed while the lane change proposal is not being carried out by the proposal unit 57. The second operation input, as noted previously, is an operation input to the second input unit 70B.

The lane change control unit (control unit) 62 carries out the lane change on the basis of an operation input performed by the user in response to the lane change proposal issued by the proposal unit 57. The lane change control unit 62 carries out the lane change in the case that the first operation input is performed by the user in response to the lane change proposal issued by the proposal unit 57. The first operation input, as noted previously, is an operation input to the first input unit 70A. Further, the lane change control unit 62 does not carry out the lane change in the case that the second operation input is performed by the user in response to the lane change proposal issued by the proposal unit 57. Stated otherwise, in this case, execution of the lane change is restricted. The second operation input, as noted previously, is an operation input to the second input unit 70B.

In the present embodiment, such a configuration is employed for the following reasons. More specifically, as noted previously, the first input unit 70A is capable of being pressed when the predetermined function is activated or the like. Accordingly, when the user is in agreement with the lane change proposal issued by the proposal unit 57, pressing of the first input unit 70A is easy for the user to imagine intuitively. On the other hand, the second input unit 70B is capable of being pressed when the predetermined function is suspended or the like. Accordingly, when the user does not agree with the lane change proposal issued by the proposal unit 57, pressing of the second input unit 70B is easy for the user to imagine intuitively. In accordance with such reasoning, the present embodiment is configured in the manner described above.

Further, in the present embodiment, agreement or the like in response to the lane change proposal issued by the proposal unit 57 is capable of being performed using the operation input unit 68 provided on the steering wheel 74. This feature is provided for the following reasons. More specifically, there may be cases in which the user is not grasping the steering wheel 74 during implementation of automated driving (automated steering). Further, there may be cases in which the user is grasping the steering wheel 74 with only one hand during implementation of automated driving (automated steering). In such cases, it is not always easy for the user to operate the turn signal lever (not shown). Accordingly, in the case that agreement or the like in response to the lane change proposal is performed using the turn signal lever, suitable operability cannot be obtained. Thus, according to the present embodiment, agreement or the like in response to the lane change proposal issued by the proposal unit 57 is capable of being performed using the operation input unit 68 provided on the steering wheel 74.

The storage unit 56 includes a non-illustrated volatile memory, and a non-illustrated nonvolatile memory. As an example of the volatile memory, there may be cited a RAM (Random Access Memory). As an example of the nonvolatile memory, there may be cited a ROM (Read Only Memory), a flash memory, or the like. The external environmental information, the vehicle body behavior information, and the vehicle operation information, etc., are stored, for example, in the volatile memory. Programs, tables, maps, and the like are stored, for example, in the nonvolatile memory.

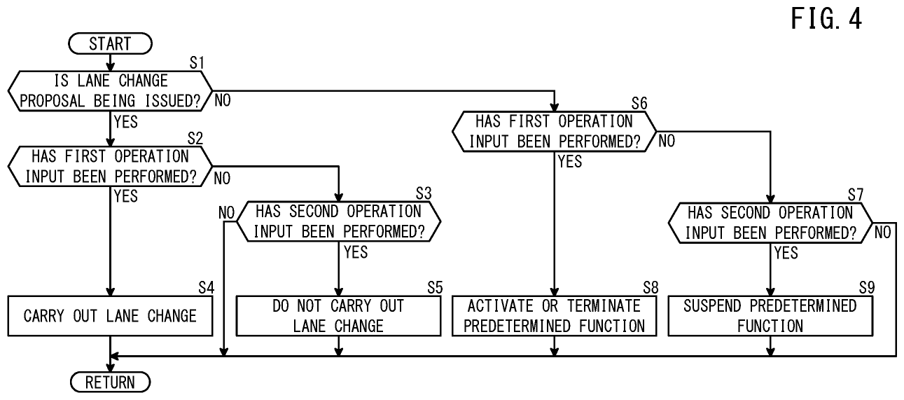

FIG. 4 is a flowchart showing an example of operations of the vehicle control device according to the present embodiment.

In step S1, the computation unit 54 determines whether or not the lane change proposal is being issued by the proposal unit 57. In the case that the lane change proposal is being issued by the proposal unit 57 (YES in step S1), the process transitions to step S2. In the case that the lane change proposal is not being issued by the proposal unit 57 (NO in step S1), the process transitions to step S6.

In step S2, on the basis of a signal supplied from the first switch 68A, the operation detection unit 58 detects whether or not the first operation input has been performed by the user. The first operation input, as noted previously, is an operation input to the first input unit 70A. In the case that the first operation input is performed (YES in step S2), the process transitions to step S4. In the case that the first operation input is not performed (NO in step S2), the process transitions to step S3.

In step S3, on the basis of a signal supplied from the second switch 68B, the operation detection unit 58 detects whether or not the second operation input has been performed by the user. The second operation input, as noted previously, is an operation input to the second input unit 70B. In the case that the second operation input is performed (YES in step S3), the process transitions to step S5. In the case that the second operation input is not performed (NO in step S3), the process shown in FIG. 4 is brought to an end.

In step S4, the lane change control unit 62 carries out the lane change. In the case that step S4 has been executed, the process shown in FIG. 4 is brought to an end.

In step S5, the lane change control unit 62 does not carry out the lane change. In the case that step S5 has been executed, the process shown in FIG. 4 is brought to an end.

In step S6, on the basis of a signal supplied from the first switch 68A, the operation detection unit 58 detects whether or not the first operation input has been performed by the user. The first operation input, as noted previously, is an operation input to the first input unit 70A. In the case that the first operation input is performed (YES in step S6), the process transitions to step S8. In the case that the first operation input is not performed (NO in step S6), the process transitions to step S7.

In step S7, on the basis of a signal supplied from the second switch 68B, the operation detection unit 58 detects whether or not the second operation input has been performed by the user. The second operation input, as noted previously, is an operation input to the second input unit 70B. In the case that the second operation input is performed (YES in step S7), the process transitions to step S9. In the case that the second operation input is not performed (NO in step S7), the process shown in FIG. 4 is brought to an end.

In step S8, the computation unit 54 either activates or terminates the predetermined function. More specifically, in the case that the first operation input is performed in step S6 in a state in which the predetermined function has not been activated, then in step S8, the computation unit 54 activates the predetermined function. In the case that the first operation input is performed in step S6 in a state in which the predetermined function is activated, the computation unit 54 terminates the predetermined function. In the case that step S8 has been executed, the process shown in FIG. 4 is brought to an end.

In step S9, the computation unit 54 suspends the predetermined function. More specifically, in such a case, the computation unit 54 causes the predetermined function to transition into a standby state. In the case that step S9 has been executed, the process shown in FIG. 4 is brought to an end.

In the foregoing manner, according to the present embodiment, the lane change control unit 62 carries out the lane change in the case that the first operation input is performed by the user in response to the lane change proposal issued by the proposal unit 57. Further, the lane change control unit 62 does not carry out the lane change in the case that the second operation input is performed by the user in response to the lane change proposal issued by the proposal unit 57. The first operation input can be performed when the predetermined function is activated or the like. Accordingly, when the user is in agreement with the lane change proposal issued by the proposal unit 57, how to perform the first operation input is easy for the user to imagine intuitively. On the other hand, the second operation input can be performed when the predetermined function is suspended. Accordingly, when the user is not in agreement with the lane change proposal issued by the proposal unit 57, how to perform the second operation input is easy for the user to imagine intuitively. Therefore, according to the present embodiment, it is possible for the vehicle control device 12 having suitable operability to be provided.

### Modification 1

A vehicle control device, a vehicle, and a vehicle control method according to a first modification of the present embodiment will be described with reference to the drawings.

According to the present modification, in the case that neither the first operation input nor the second operation input is performed within a predetermined time period in response to the lane change proposal issued by the proposal unit 57, the lane change is not carried out.

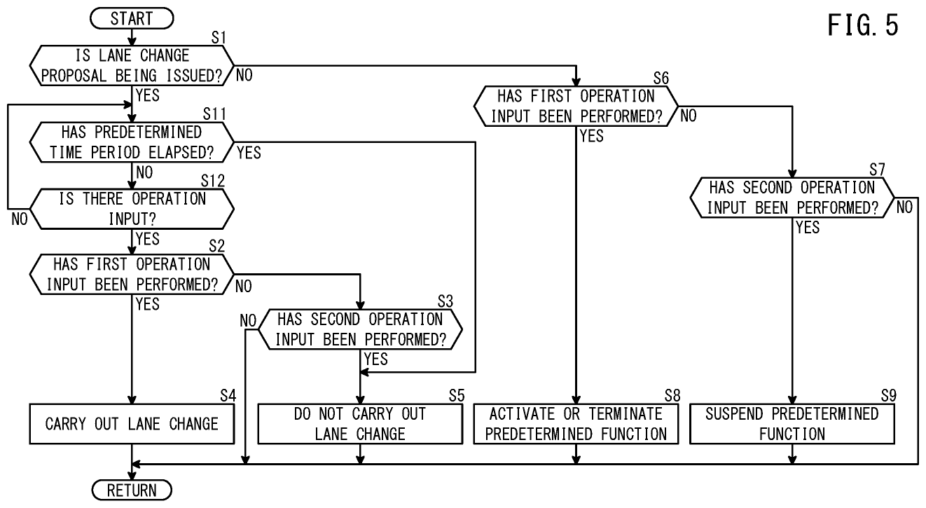

FIG. 5 is a flowchart illustrating an example of operations of the vehicle control device according to the present modification.

In step S1, the computation unit 54 determines whether or not the lane change proposal is being issued by the proposal unit 57. In the case that the lane change proposal is being issued by the proposal unit 57 (YES in step S1), the process transitions to step S11. In the case that the lane change proposal is not being issued by the proposal unit 57 (NO in step S1), the process transitions to step S6.

In step S11, the computation unit 54 determines whether or not a predetermined time period has elapsed from the timing at which the lane change proposal was issued by the proposal unit 57. In the case that the predetermined time period has not elapsed from the timing at which the lane change proposal was issued by the proposal unit 57 (NO in step S11), the process transitions to step S12. In the case that the predetermined time period has elapsed from the timing at which the lane change proposal was issued by the proposal unit 57 (YES in step S11), the process transitions to step S5.

In step S12, on the basis of signals supplied from the first switch 68A and the second switch 68B, the computation unit 54 detects whether or not an operation input to the operation input unit 68 has been detected by the operation detection unit 58. In the case that the operation input to the operation input unit 68 is not detected by the operation detection unit 58 (NO in step S12), the process returns to step S11. In the case that the operation input to the operation input unit 68 is detected by the operation detection unit 58 (YES in step S12), the process transitions to step S2.

Steps S2 to S9 are the same as steps S2 to S9 described above with reference to FIG. 4, and therefore, description of these steps is omitted.

In the foregoing manner, in the case that neither the first operation input nor the second operation input is performed within the predetermined time period in response to the lane change proposal issued by the proposal unit 57, the lane change control unit 62 may be operated so as not to carry out the lane change. According to the present modification, after the predetermined time period has elapsed, it is possible to instruct activation, termination, or suspension of the predetermined function using the operation input unit 68.

### Modification 2

A vehicle control device, a vehicle, and a vehicle control method according to a second modification of the present embodiment will be described with reference to the drawings.

In the present modification, in the case that the second operation input is performed in response to the lane change proposal issued by the proposal unit 57, the proposal unit 57 suppresses a next issuance of the lane change proposal.

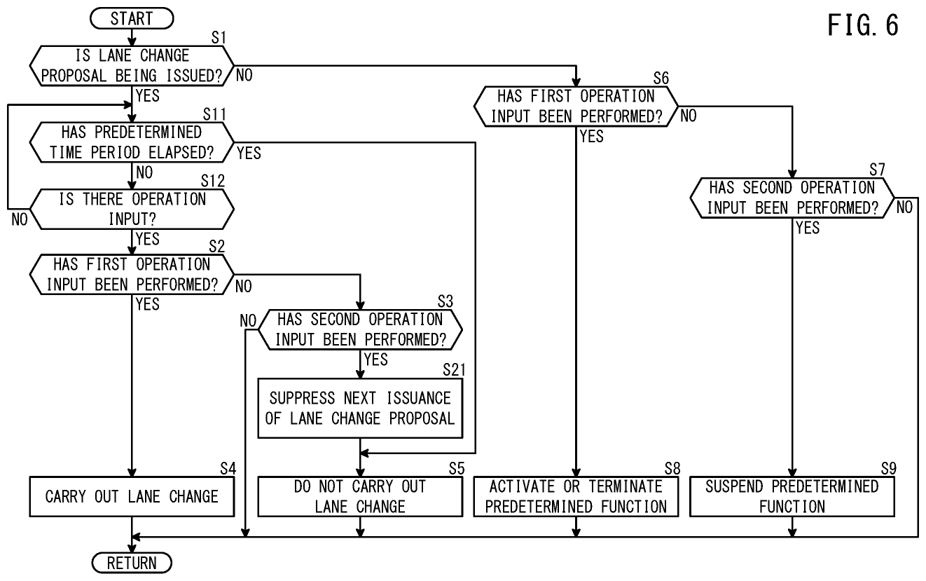

FIG. 6 is a flowchart illustrating an example of operations of the vehicle control device according to the present modification.

Step S1, step S11, step S12, and step S2 are the same as step S1, step S11, step S12, and step S2 described above with reference to FIG. 4 or FIG. 5, and therefore, description of these steps is omitted.

In step S3, on the basis of a signal supplied from the second switch 68B, the operation detection unit 58 detects whether or not the second operation input has been performed by the user. More specifically, the operation detection unit 58 determines whether or not the operation input detected in step S12 is the second operation input. The second operation input, as noted previously, is an operation input to the second input unit 70B. In the case that the second operation input is performed (YES in step S3), the process transitions to step S21. In the case that the second operation input is not performed (NO in step S3), the process shown in FIG. 6 is brought to an end.

In step S21, the computation unit 54 controls the proposal unit 57 in a manner so that the next issuance of the lane change proposal is suppressed. Upon completion of step S21, the process transitions to step S5.

Steps S4 to S9 are the same as steps S4 to S9 described above with reference to FIG. 4, and therefore, description of these steps is omitted.

In this manner, according to the present modification, in the case that the second operation input is performed in response to the lane change proposal issued by the proposal unit 57, the proposal unit 57 suppresses the next issuance of the lane change proposal. Further, in the present modification, in the case that a predetermined time period has elapsed in response to the lane change proposal issued by the proposal unit 57, the proposal unit 57 suppresses the next issuance of the lane change proposal.

Although preferred embodiments of the present invention have been described above, the present invention is not limited to the above-described embodiments, and various modifications can be made thereto without departing from the essence and gist of the present invention.

Summarizing the above-described embodiment and modifications thereof, the characteristic features described below are realized.

The vehicle control device (12) comprises the proposal unit (57) that issues the lane change proposal, which is a proposal to make a lane change, to a user, the operation detection unit (58) that detects the operation input performed by the user to the operation input unit (68), to which the first operation input to instruct activation or termination of the predetermined function and the second operation input to instruct suspension of the predetermined function can be performed, and the lane change control unit (62) that controls the lane change on the basis of the operation input performed by the user in response to the lane change proposal issued by the proposal unit in a state in which the predetermined function is operating, wherein the lane change control unit carries out the lane change in the case that the first operation input is performed by the user in response to the lane change proposal issued by the proposal unit, and does not carry out the lane change in the case that the second operation input is performed by the user in response to the lane change proposal issued by the proposal unit. The first operation input can be performed when the predetermined function is activated or the like. Accordingly, when the user is in agreement with the lane change proposal issued by the proposal unit, how to perform the first operation input is easy for the user to imagine intuitively. On the other hand, the second operation input can be performed when the predetermined function is suspended. Accordingly, when the user is not in agreement with the lane change proposal issued by the proposal unit, how to perform the second operation input is easy for the user to imagine intuitively. Thus, in accordance with such a configuration, it is possible for the vehicle control device having suitable operability to be provided.

The above-described vehicle control device may further include the predetermined function control unit (60) that controls execution of the predetermined function, wherein the predetermined function control unit may activate or terminate the predetermined function in the case that the first operation input is performed when the lane change proposal is not being issued by the proposal unit, and may suspend the predetermined function in the case that the second operation input is performed when the lane change proposal is not being issued by the proposal unit. In accordance with such a configuration, when the lane change proposal is not being issued by the proposal unit, it is possible to carry out the instruction to start, terminate, or suspend the predetermined function using the operation input unit.

The predetermined function may be a following function or a lane keeping function. In accordance with such a configuration, agreement or disagreement with respect to the lane change proposal can be input using the operation input unit, with which the operation of starting, terminating, or suspending the following function or the lane keeping function can be performed.

In the case that neither the first operation input nor the second operation input is performed within a predetermined time period in response to the lane change proposal issued by the proposal unit, the lane change need not be carried out. In accordance with such a configuration, after the predetermined time period has elapsed, using the operation input unit, it is possible to instruct activation, termination, or suspension of the predetermined function.

In the case that the second operation input is performed in response to the lane change proposal issued by the proposal unit, the proposal unit may suppress a next issuance of the lane change proposal. In accordance with such a configuration, it is possible to prevent the next issuance of the lane change proposal from being carried out.

The operation input unit may be provided on the steering wheel (74). In accordance with such a configuration, since the input of agreement or disagreement with respect to the lane change proposal can be performed using the operation input unit provided on the steering wheel, it is possible to provide the vehicle control device having suitable operability.

The operation input unit may comprise the first input unit (70A), and the second input unit (70B) that differs from the first input unit, the first operation input may be performed by operating the first input unit, and the second operation input may be performed by operating the second input unit.

The vehicle (10) comprises the vehicle control device as described above.

The vehicle control method includes the step (step S1) of issuing the lane change proposal, which is a proposal to make a lane change, to the user, the step (step S2, step S3) of detecting the operation input performed by the user to the operation input unit, to which the first operation input to instruct activation or termination of the predetermined function and the second operation input to instruct suspension of the predetermined function can be performed, and the step (step S4, step S5) of controlling the lane change on the basis of the operation input performed by the user in response to the lane change proposal issued in a state in which the predetermined function is operating, wherein, in the step of controlling the lane change, the lane change is carried out (step S4) in the case that the first operation input is performed by the user in response to the lane change proposal (step S2), and the lane change is not carried out (step S5) in the case that the second operation input is performed by the user in response to the lane change proposal (step S3).

What is claimed is:

1. A vehicle control device, comprising:
a proposal unit configured to issue a lane change proposal, which is a proposal to make a lane change, to a user;
an operation detection unit configured to detect an operation input performed by the user to an operation input unit, to which a first operation input to instruct activation or termination of a predetermined function and a second operation input to instruct suspension of the predetermined function are configured to be performed; and
a lane change control unit configured to control the lane change on a basis of the operation input performed by the user in response to the lane change proposal issued by the proposal unit in a state in which the predetermined function is operating,
wherein the lane change control unit carries out the lane change in a case that the first operation input is performed by the user in response to the lane change proposal issued by the proposal unit, and does not carry out the lane change in a case that the second operation input is performed by the user in response to the lane change proposal issued by the proposal unit.

2. The vehicle control device according to claim 1, further comprising a predetermined function control unit configured to control execution of the predetermined function,
wherein the predetermined function control unit activates or terminates the predetermined function in a case that the first operation input is performed when the lane change proposal is not being issued by the proposal unit, and suspends the predetermined function in a case that the second operation input is performed when the lane change proposal is not being issued by the proposal unit.

3. The vehicle control device according to claim 2, wherein the predetermined function is a following function or a lane keeping function.

4. The vehicle control device according to claim 1, wherein, in a case that neither the first operation input nor the second operation input is performed within a predetermined time period in response to the lane change proposal issued by the proposal unit, the lane change is not carried out.

5. The vehicle control device according to claim 1, wherein, in a case that the second operation input is performed in response to the lane change proposal issued by the proposal unit, the proposal unit suppresses a next issuance of the lane change proposal.

6. The vehicle control device according to claim 1, wherein the operation input unit is provided on a steering wheel.

7. The vehicle control device according to claim 1, wherein:
the operation input unit comprises a first input unit, and a second input unit that differs from the first input unit;
the first operation input is performed by operating the first input unit; and
the second operation input is performed by operating the second input unit.

8. A vehicle comprising a vehicle control device, the vehicle control device comprising:
a proposal unit configured to issue a lane change proposal, which is a proposal to make a lane change, to a user;
an operation detection unit configured to detect an operation input performed by the user to an operation input unit, to which a first operation input to instruct activation or termination of a predetermined function and a second operation input to instruct suspension of the predetermined function are configured to be performed; and
a lane change control unit configured to control the lane change on a basis of the operation input performed by the user in response to the lane change proposal issued by the proposal unit in a state in which the predetermined function is operating,
wherein the lane change control unit carries out the lane change in a case that the first operation input is performed by the user in response to the lane change proposal issued by the proposal unit, and does not carry out the lane change in a case that the second operation input is performed by the user in response to the lane change proposal issued by the proposal unit.

9. A vehicle control method, comprising:
a step of issuing a lane change proposal, which is a proposal to make a lane change, to a user;
a step of detecting an operation input performed by the user to an operation input unit, to which a first operation input to instruct activation or termination of a predetermined function and a second operation input to instruct suspension of the predetermined function are configured to be performed; and
a step of controlling the lane change on a basis of the operation input performed by the user in response to the lane change proposal issued in a state in which the predetermined function is operating,
wherein, in the step of controlling the lane change, the lane change is carried out in a case that the first operation input is performed by the user in response to the lane change proposal, and the lane change is not carried out in a case that the second operation input is performed by the user in response to the lane change proposal.
